(19) United States
(12) Patent Application Publication
(10) Pub. No.: US 2006/0145027 A1
(43) Pub. Date: Jul. 6, 2006

(54) Method of controlling vortex bursting

(76) Inventors: Clyde Warsop, Filton (GB); Mark Watson, Manchester (GB); Artur J Jaworski, Manchester (GB)

Correspondence Address: NIXON & VANDERHYE, PC, 901 NORTH GLEBE ROAD, 11TH FLOOR, ARLINGTON, VA, 22203, US

(21) Appl. No.: 10/502,704

(22) PCT Filed: Jun. 9, 2004
(86) PCT No.: PCT/GB04/02436

§ 371 Date: Jul. 28, 2004

(30) Foreign Application Priority Data
Jun. 11, 2003 (GB) 0313523.3
Jun. 11, 2003 (EP) 03253616.1

(51) Int. Cl. B64C 21/04

(52) U.S. Cl. 244/207

(57) ABSTRACT

This invention relates to a method of controlling vortex bursting on an aerodynamic surface (20) associated with separated flows and, in particular, relates to control of separated flows over aerodynamic or hydrodynamic surfaces (20) that may have highly swept leading edges (26). A method of controlling vortex bursting on an aerodynamic surface or a hydrodynamic surface (20) is provided, the surface (20) comprising a gas source (22) located on or in the surface (20) and the method comprising the step of repeatedly operating the gas source (22) thereby to eject a flow of gas into an airflow passing over the surface (20). Effective control of the frequency at which the gas source (22) is operated has been found to reduce pressures on the surface (20) caused by vortex bursting. The present invention also provides a synthetic jet actuator (22) and an aerodynamic or hydrodynamic surface (20) comprising a plurality of such discrete synthetic jet actuators (22).

This invention relates to a method of controlling vortex bursting on an aerodynamic surface associated with separated flows and, in particular, relates to control of flows over aerodynamic or hydrodynamic surfaces that may have highly-swept leading edges.

Many high-performance aircraft and missiles employ lifting surfaces that have highly-swept leading edges, e.g. delta wings. Such wings utilise a strong axial vortex over their upper surface to augment the lift force they can produce at various angles of attack. The vortex is derived from flow separation at the leading edge of the wing that, at high sweep angles, forms a separated shear layer that rolls up to form a strong, steady lift-inducing vortex. The conical vortex structure originates at the apex of the wing, grows along the leading edge of the wing and passes into the wake behind the wing.

When a certain angle of attack is exceeded, this organised vortex structure rapidly stagnates and collapses at a point above the wing resulting in a highly unsteady flow region over a portion of the wing lifting surface, generally towards its trailing edge. This phenomenon is usually referred to as vortex burst or vortex breakdown. Vortex breakdown leads to unsteady flow over the rest of the wing. As the angle of attack is increased, the location of vortex bursts moves forward towards the apex of the wing leading to a greater portion of the wing being exposed to unsteady flow. The unsteady flow may cause significant structural loading of the wing and other adjacent components (so-called “buffeting”) that will lead to premature fatigue problems and even catastrophic failure.

The problem of buffeting became evident early on in the operational life of the F18 military aircraft where buffeting of the tail fins was identified as a problem. This was addressed not only by a structural re-design of the tail fins, but also by the employment of a passive mechanical strake on the wing's upper surface to steer the leading edge vortex away from the tail fins and hence control the propagation of vortices. In addition, mechanical structures such as strakes and the like may be placed on the leading edge to control flow separation and hence vortex formation.

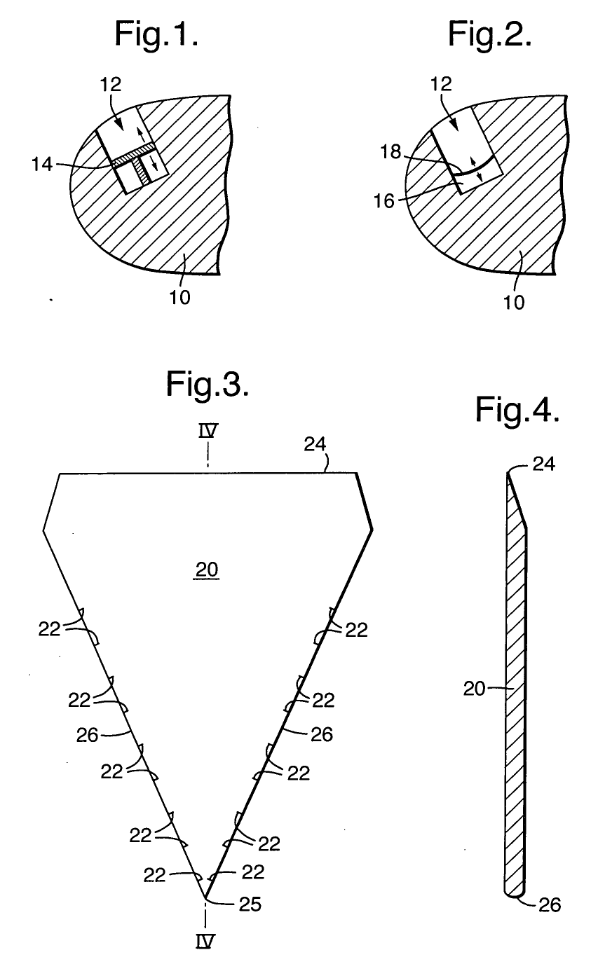

U.S. Pat. No. 4,697,769 to Blackwelder describes a device for use on delta wings and the like for varying the lift generated by the wing. Spanwise ‘synthetic jet’ slot devices are employed that extend along the leading edge of the wing and examples of two such devices are shown in FIGS. 1 and 2 herein. In FIG. 1, a piston 14 is provided so that the volume of the slot 12 can be varied. Similarly, the volume of the slot 12 is varied in FIG. 2, this time by a speaker 16 with a diaphragm 18. The piston 14 or diaphragm 18 is driven in the direction shown by the arrows in FIG. 1 and FIG. 2 thereby forcing a jet of air out into the air flow over the leading edge of the wing 10 thereby influencing flow separation and, as a consequence, the lift generated by the wing 10. Two frequencies of operation of the synthetic jet devices are mentioned. The first is half the shedding frequency of vortices on the wing leading edge such that an increase in lift is achieved. The second is twice the shedding frequency such that a decrease in lift is achieved (this is useful in combination with using half the frequency so that turns may be achieved by increasing the lift on one wing while decreasing the lift on the other). Typical shedding frequencies are provided of 12 Hz for a lifting surface travelling through water at 0.8 ms⁻¹ and of 30 Hz for a military jet travelling at 600 ms⁻¹.

It is an aim of the present invention to alleviate the problem of unsteady separated flows over an aerodynamic lifting surface, thereby reducing the problems associated with vortex bursting.

Against this background, and from a first aspect, the present invention resides in a method of controlling vortex bursting on an aerodynamic surface or a hydrodynamic surface, the surface comprising a gas source located on or in the surface and the method comprising the step of repeatedly operating the gas source thereby to eject a flow of gas into an airflow passing over the surface. This is in contrast to the method described in Blackwelder where jets of air are used to alter the lift generated by an aerodynamic surface.

Optionally, the gas source is located on or in a leading edge of the surface. This ensures control of flow separation that leads to vortex formation and subsequent vortex bursts.

Preferably, the method further comprises the step of providing the gas source with a periodic signal thereby to cause the gas source to respond by ejecting a flow of gas periodically. This signal may be sinusoidal, impulse, square or amplitude modulated to effect repeated operation of the gas source.

Optionally, the method further comprises the step of providing a signal with a frequency at least as large as the dominant frequencies in the variation of pressures on the wing caused by vortex bursts. These frequencies have been found to be effective in controlling vortex bursting. Moreover, they are in contrast to the lower frequencies employed by Blackwelder for the purposes of controlling lift from an aerodynamic surface. The difference in frequencies arises from the fact Blackwelder operates at frequencies linked to the shedding frequency of vortices on the wing leading edge, whereas the present invention operates at frequencies linked to pressure variation at the vortex burst site. Optionally, the method comprises the step of providing a signal with a frequency that is a harmonic or sub-harmonic of a dominant frequency in the variation of pressures on the wing caused by vortex bursts. Preferably, the method further comprises the step of providing a signal with a frequency an order of magnitude larger than the dominant frequencies in the variation of pressures on the wing caused by vortex bursts. In a currently preferred embodiment, a signal with a frequency in the range 800 Hz to 1200 Hz is employed.

Optionally, the surface comprises a plurality of gas sources and the method further comprises the step of operating the gas sources in phase. Alternatively, the gas sources may be operated out of phase such that, for example, the flow of gas ejected by each gas source into the airflow passing over the surface reaches a common point or common line coincidentally.

From a second aspect, the present invention resides in a synthetic jet actuator comprising a cavity defined by an enclosing wall and a moveable element, wherein the enclosing wall is provided with an orifice to allow flow of a gas into and out from the cavity and the moveable element is operable to vary the volume of the cavity thereby causing gas to pass into and out from the cavity. Providing a relatively-small orifice relative to the cavity ensures that gas is ejected from the cavity as a stream of vortical, jet-like disturbances.

Optionally, the orifice is a rectangular slit. Alternatively, the orifice has a circular cross-section and may optionally have a diameter of less than 1 cm, 1 mm being particularly preferred.

Preferably, the moveable element is a piston. Alternatively, the moveable element is a diaphragm and, optionally, the diaphragm is held in position against a shoulder provided in the enclosing wall.

From a third aspect, the present invention resides in an aerodynamic or hydrodynamic surface comprising a plurality of discrete synthetic jet actuators arranged along a leading edge of the surface. Any of the synthetic jet actuators may be as already described above.

The present invention also resides in an aircraft wing comprising the aerodynamic surface described immediately above. The wing may be delta shaped. In addition, the present invention also resides in an aircraft comprising such an aircraft wing (delta shaped or otherwise).

In order that the invention may be more readily understood, a preferred embodiment is now described by way of example only with reference to the following Figures in which:

FIG. 1 shows a first synthetic jet device according to the prior art;

FIG. 2 shows a second synthetic jet device according to the prior art;

FIG. 3 is a plan view of a delta wing showing the location of eighteen discrete orifice synthetic jet actuators according to one embodiment of the present invention;

FIG. 4 is a cross-sectional view taken along line IV-IV of FIG. 3;

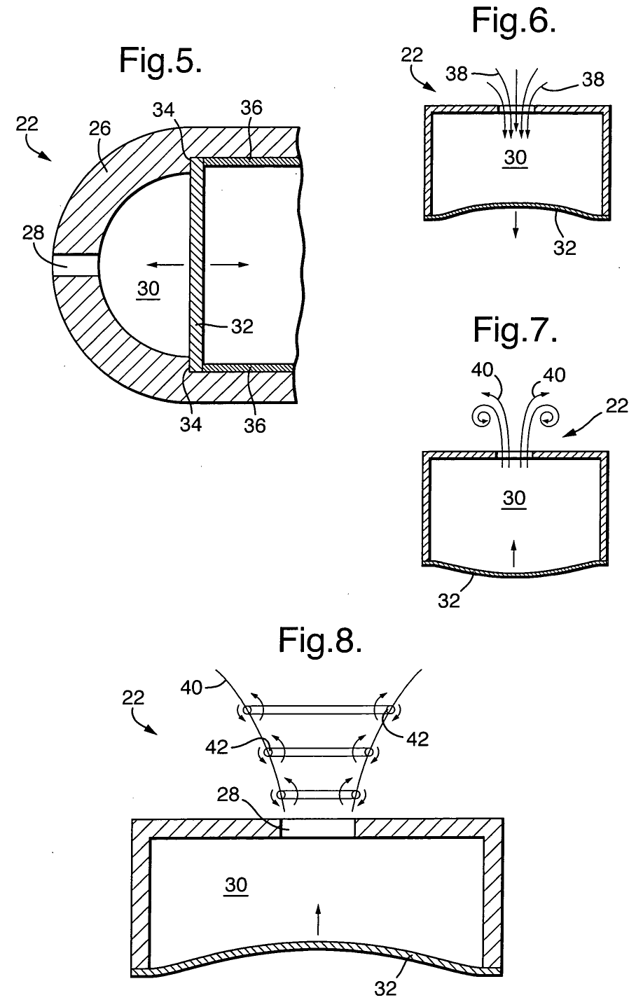

FIG. 5 is a cross-sectional view of the leading edge of the wing of FIG. 3, showing a synthetic jet actuator according to one embodiment of the present invention;

FIG. 6 is a schematic representation of a synthetic jet actuator showing air being drawn into the actuator;

FIG. 7 corresponds to FIG. 6, but shows air being expelled from the actuator;

FIG. 8 corresponds to FIG. 7, but shows detail of the vortex rings formed in the jet of air expelled from the actuator;

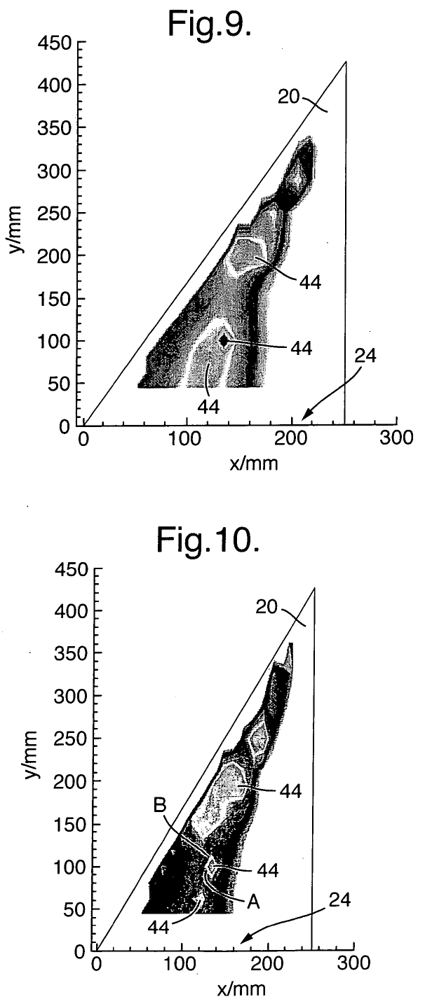

FIG. 9 is an RMS pressure distribution map of pressures over the delta wing when the synthetic jet actuators are not in operation;

FIG. 10 corresponds to FIG. 9, but for when the synthetic jet actuators are operating at 200 Hz,

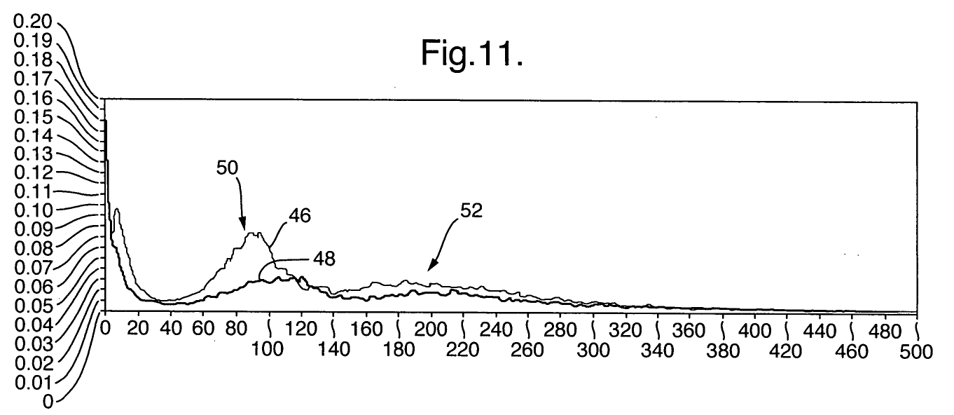

FIG. 11 is a plot of power spectral density against actuator frequency for location A in FIG. 3; and

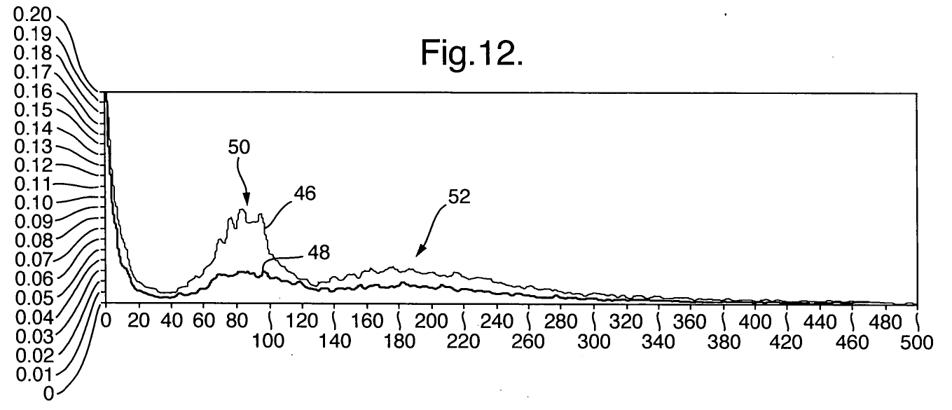

FIG. 12 corresponds to FIG. 11 but for location B in FIG. 3.

FIG. 3 shows a delta wing 20 containing eighteen synthetic jet actuators 22. The wing 20 has a sweep angle of 60° and has a sharp trailing edge 24 formed by a bevelled lower surface, as best seen in the cross-sectional view of FIG. 4. The absolute shape and size of the wing 20 is not critical to the invention and any details given herein are for the purposes of illustration only.

The eighteen actuators 22 are located on the curved leading edge 26 of the wing 20, nine actuators 22 on each side of the apex 25 arranged in symmetric fashion. The actuators 22 are located in a region up-stream of the primary separation line which leads to roll up of the vortex. Each actuator 22 can generate a time-varying disturbance in the thin shear-layer flowing over the wing 20.

In this embodiment, the actuators 22 comprised a small cylindrical orifice 28 located over a cavity 30 as can be seen in FIG. 5. The cavity 30 is backed by a piezoelectrically-driven, vibrating diaphragm 32 that is made to oscillate in the directions indicated by the arrows of FIG. 5. The diaphragm 32 is a 15 mm diameter piezo-ceramic disk held in place against a flange 34 by a screw-in plug 36. The cavity 30 is 3 mm deep and has a diameter of 12.5 mm whilst the orifice 28 has a diameter of 1 mm. The diaphragms 32 from all actuators 22 are driven by a central signal generator (not shown) that can provide sinusoidal signals of variable frequency and amplitude.

FIGS. 6 and 7 are simplified representations of the actuator 22 of FIG. 5, and illustrate the flow of air into and out of the cavity 30 during operation of the actuator 22. Driving the diaphragm 32 away from the orifice 28 increases the volume of the cavity 30 and so draws air 38 into the cavity 30 from the region of the wing 20 surrounding the orifice 28. Driving the diaphragm 32 towards the orifice 28 decreases the volume of the cavity 30 and forces air 40 out through the orifice 28 as a stream of vortical, jet-like disturbances 42 as illustrated in FIG. 8. From our experiments, it appears that the influence of the actuators 22 on the breakdown and associated unsteadiness of the leading-edge vortical flow is significant. The peak velocity amplitude of the actuators 22 was of the order of 0.25 to 0.5 of the freestream flow. For certain key operating modes and frequencies the amplitude of the unsteady pressures on the wing 20 caused by vortex bursting could be reduced by 50% (at both the characteristic frequencies associated with the burst phenomenon). Actuation does not appear to affect the mean, steady flowfield.

In terms of how the described flow-control concept works, it is thought that the time dependent disturbances created by the actuators 22 interact with the naturally occurring dynamic structures in the shear layer that form in the region of breakdown. The amplitude, frequency and phasing of the flow actuation are thought to be of key importance and they lead to a modification in the fluid dynamic process associated with the vortex breakdown, perhaps stabilising the classical unsteadiness associated with spiral vortex breakdown modes.

Experiments were conducted in which the actuators 22 were driven in-phase at frequencies in the range from 800 Hz to 1200 Hz. These frequencies are an order of magnitude greater than the range of dominant frequencies in the variation of pressures on the wing 20 caused by vortex bursts in an unactuated flow. The reason for this choice of frequencies was that, when operated at the dominant frequencies, the actuators 22 were unable to produce a jet velocity sufficiently high to allow the fluid structures to escape the orifice 28 before they were entrained again during the actuator's suction cycle. Thus, three frequencies were chosen that spanned the range of dominant frequencies (80, 100, 120 Hz) and the diaphragms 32 were driven at ten times these frequencies as this was the lowest multiple that produced coherent structures from the actuators 22.

FIGS. 9 to 12 show results obtained during the experiments. FIG. 9 shows the RMS pressure distribution over the wing 20, as measured by an array of 137 pressing tappings, for an airflow with freestream, velocity of 15 ms⁻¹ with the delta wing 20 at a 29° angle of attack. The actuators 22 were not operating whilst the data of FIG. 9 was collected. FIG. 9 shows areas of high pressure indicated at 44 that correspond to unsteadiness associated with vortex bursts. These areas 44 are particularly severe towards the trailing edge 24 of the wing 20.

FIG. 10 corresponds to FIG. 9, but this time the actuators 22 were operating in phase at a frequency of 1200 Hz. Comparison with FIG. 9 shows that high dynamic RMS pressure seen in the areas 44 are reduced thereby reducing the effects of vortex burst on the dynamic loading on the wing 20. Hence, we have demonstrated that control of the flow unsteadiness associated with vortex bursting is possible with the actuators 22 described herein. FIGS. 11 and 12 show power spectral density against actuator frequency for two locations on the wing 20. Each figure shows a line 46 representing the actuators 22 not operating and a second line 48 representing the actuators 22 operating at 1200 Hz. FIGS. 11 and 12 show a reduction in the power spectral density at both the larger double peak 50 centred around 90 Hz and at the broader peak 52 centred around 200 Hz. Moreover, the larger peak 50 in FIG. 11 shifts to higher frequencies.

The person skilled in the art will appreciate that modifications can be made to the embodiment described above without departing from the scope of the invention.

The shape and size of the wing 20 is not critical, as the actuators 22 will find useful application in any number of wings. As well as controlling unsteady separated flows on wings, the method described herein could be applied to unsteady separated flows on other shapes (e.g. bluff bodies) where vortex bursting is a problem. Examples include missile and aircraft forebodies and tailfins.

In addition, the design of the actuators 22 can be varied. The above embodiment uses an oscillating diaphragm 32, but other devices such as a reciprocating piston could be used instead. The shape of the orifice 28 can also be varied from the circular cross-section described above to any number of shapes such as small rectangular slits. In addition, the embodiment described above has the orifices 28 and cavities 30 oriented to be normal to the leading edge 26 of the wing 20. Alternative arrangements include skewing and pitching the jets so that they are off-normal relative to the leading edge 26. The size and number of actuators 22 can also be varied, as can their mode of operation. Although advantageous, it is not necessary for the actuators 22 to be located on the leading edge 26 of the wing 20: clearly, locating the actuators 22 a small distance behind the leading edge 26 will also be beneficial.

In addition to driving the diaphragms 32 of the actuators 22 with sinusoidal signals provided by the central signal generator, other waveforms such as impulse, square or amplitude modulated may be used. Rather than operating all actuators 22 in phase, the actuators may be operated out of phase. For example, a phase offset could be introduced between adjacent actuators 22 such that the disturbances they create reach the location of vortex bursting coincidentally.

Whereas the actuators 22 described above blow air out from and draw into the cavity 30, they may be adapted to blow air out only. This may be achieved by using the diaphragm 32 in association with a one-way valve such that air is taken into the cavity 30 from an air supply internal to the wing. Alternatively, a pulsed high-pressure air supply could be used to expel air through the orifice 28.

It will be clear that the many of the above alternatives are independent of one another and so can be combined freely as desired. By way of example, the phase of the actuators 22 and the signal with which they are driven may be varied in response to a feedback loop. The feedback loop may be linked to an array of pressure sensors provided on the wing 20 that provides information regarding the location of vortex bursts on the wing, along with other information such as any characteristic frequencies of the vortex bursts.

1. A method of controlling vortex bursting in airflow over a highly swept wing having a leading edge, the method comprising the step ejecting a flow of gas from the leading edge of said wing into said airflow passing over the wing.

2. (canceled)

3. The method of claim 1, wherein said ejecting step comprises the step of ejecting said flow of gas periodically.

4. The method of claim 3, wherein said ejecting step further includes the step of providing said periodic gas flow with a frequency at least as large as the dominant frequencies in the variation of pressures on the wing caused by vortex bursts.

5. The method of claim 4, wherein said periodic gas flow frequency is a frequency that is one of a harmonic and sub-harmonic of a dominant frequency in the variation of pressures on the wing caused by vortex bursts.

6. The method of claim 4, wherein said periodic gas flow frequency is a frequency an order of magnitude larger than the dominant frequencies in the variation of pressures on the wing caused by vortex bursts.

7. The method of claim 6, wherein said periodic gas flow frequency is a frequency in the range 800 HZ to 1200 Hz.

8. The method of claim 1, wherein said ejecting step includes the step of providing a plurality of locations of gas flow from said leading edge and further comprises the step of operating plurality of locations of gas flow in phase.

9. (canceled)

10. (canceled)

11. (canceled)

12. (canceled)

13. (canceled)

14. (canceled)

15. (canceled)

16. (canceled)

17. A highly swept aircraft wing comprising a plurality of discrete synthetic jet actuators arranged along a leading edge of the wing.

18. (canceled)

19. (canceled)

20. (canceled)

21. An aircraft comprising the highly swept aircraft wing of claim 17.

22. (canceled)

23. (canceled)

24. (canceled)

25. An apparatus for controlling vortex bursting in airflow over a highly swept wing having a leading edge, said apparatus comprising at least one structure for ejecting a flow of gas from the leading edge of said wing into said airflow passing over the wing.

26. The apparatus of claim 25, wherein said at least one structure comprises a structure for ejecting said flow of gas periodically.

27. The apparatus of claim 26, wherein said at least one structure further comprises a structure for ejecting said periodic gas flow with a frequency at least as large as the dominant frequencies in the variation of pressures on the wing caused by vortex bursts.

28. The apparatus of claim 27, wherein said periodic gas flow frequency is a frequency that is one of a harmonic and sub-harmonic of a dominant frequency in the variation of pressures on the wing caused by vortex bursts.

29. The apparatus of claim 27, wherein said periodic gas flow frequency is a frequency an order of magnitude larger than the dominant frequencies in the variation of pressures on the wing caused by vortex bursts.

30. The apparatus of claim 29, wherein said periodic gas flow frequency is a frequency in the range 800 HZ to 1200 Hz.

31. The apparatus of claim 25, wherein a plurality of said structures are provided at a plurality of locations along said leading edge and further said plurality of structures synchronized to operate in phase.
